(19) United States
(12) Patent Application Publication
(10) Pub. No.: US 2006/0042501 A1
(43) Pub. Date: Mar. 2, 2006

(54) Polishing liquid

(76) Inventor: Kazuya Miyazaki, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 11/209,820

(22) Filed: Aug. 24, 2005

(30) Foreign Application Priority Data
Aug. 24, 2004 (JP) 2004-243796

(51) Int. Cl. C09G 1/02

(52) U.S. Cl. 106/3

(57) ABSTRACT

In order to obtain a high polishing efficiency by maintaining pH value of polishing liquid constant for a long time, as a polishing liquid used upon polishing the surface of a semiconductor wafer using an abrasive grain fixed polishing pad in which abrasive grains are incorporated in a polishing pad, it is prepared by mixing at least an inorganic alkali, a salt, and an organic alkali.

### BACKGROUND OF THE INVENTION

1. Field of the Invention

The present invention relates to a polishing liquid, and more particularly relates to a polishing liquid used upon polishing the surface of a semiconductor wafer by using an abrasive grain fixed polishing pad in which abrasive grains are incorporated to a polishing pad.

2. Related Art

A multi-layered wiring technique is one of LSI (Large Scale Integrated circuit) high integration technology in recent years. The multi-layered wiring technique is a wiring technique of sterically forming a semiconductor circuit on a silicon wafer and it has been rapidly popularized as a technique capable of increasing the circuit scale per unit area. For forming such a multi-layered wiring on a silicon wafer, it is necessary to apply a planarizing step for a semiconductor wafer by using a CMP (Chemical Mechanical Polishing) apparatus before stacking new wirings in the wafer process such that exposure can be conducted with margin even at a shallow focal depth to the surface of a lower layer as a base.

Further, the CMP apparatus described above is essential also for conducting a damascene process necessary for copper wiring technique for attaining high speed LSI operation. The damascene process is a burying technique of wiring materials, which is a process of forming a thin film so as to bury a wiring material in grooves formed to an insulation film and removing excess a thin film formed outside of the grooves by CMP.

Further, with a recent trend of decreasing the size and reducing the thickness of semiconductor devices, it has been required for reducing the thickness of the semiconductor wafer. For reducing the thickness of the semiconductor wafer, it has been conducted to mechanically grind the rear face of a semiconductor wafer by a grinding stone or the like and then polishing the rear face (ground surface) of the semiconductor wafer by a CMP apparatus so as to remove stresses remaining on the ground surface or improving the transverse rupture strength.

As described above, CMP has become necessary in various steps in the field of semiconductor production. In CMP, the surface of the semiconductor wafer is polished by using a polishing pad made of a non-woven fabric and a polishing liquid containing loose abrasives. However, in CMP using the polishing pad made of non-woven fabric, since a polishing liquid containing loose abrasives is used, it is difficult to simply treat liquid wastes because most of loose abrasives (for example, silica) remain in the liquid wastes. Further, since the consumption amount of the abrasive grains upon polishing is usually about 3 to 4% for the entire abrasive grains, most of the abrasive grains are consumed wastefully without contributing to polishing.

With the background described above, it has been studied on CMP using an abrasive grain fixed polishing pad in which abrasive grains are incorporated in a polishing pad, without using the polishing liquid containing loose abrasives. In the CMP using the abrasive grain fixed polishing pad, since a polishing liquid not containing loose abrasives (for example, alkali solution) can be used, most of abrasive grains (for example, silica) are consumed while contributing to polishing. Accordingly, since abrasive grains scarcely remain in the liquid wastes, it can be expected that the liquid wastes can be utilized again efficiently by filtration. Further, when compared with the CMP using loose abrasives, the running cost for the polishing step can be decreased greatly since the abrasive grains are not consumed wastefully.

For the CMP using the abrasive grain fixed polishing pad described above, JP-A-2002-164306 discloses the use of a polishing liquid including, for example, purified water, an amine, a chelating agent and an alkali agent as a polishing liquid not containing loose abrasives in a case of polishing a semiconductor wafer (for example, silicon wafer). The polishing efficiency for the semiconductor wafer is improved by using such polishing liquid, while the polishing efficiency for the semiconductor wafer is not favorable when merely purified water is used as the polishing liquid. Further, since the polishing liquid forms complex compounds with metal elements, contamination on the surface of the semiconductor wafer with the metal elements can be prevented.

Further, as another example, JP-A-2002-252189 discloses that the polishing efficiency for the semiconductor wafer can be improved by using a polishing liquid including purified water and an inorganic alkali agent.

### SUMMARY OF THE INVENTION

As a result of experiment made by the present inventors, et al., however, while the polishing efficiency for the semiconductor wafer can be improved by using each of the polishing liquids described above, compared with a case of using purified water as a polishing liquid, it has been recognized a problem that the polishing efficiency is not stable and a high constant polishing efficiency can not be maintained. It is supposed that the polishing efficiency cannot be maintained constant, because the pH value of the polishing liquid is not stable for a time but fluctuates time-dependently.

Further, it is also recognized a problem that due to the time-dependent change of the pH value of the polishing liquid, not only the polishing accuracy varies on every individual semiconductor wafers but also re-use of the liquid wastes by recycling is difficult.

Accordingly, an object of the present invention is to provide a novel and improved polishing liquid capable of maintaining the pH value of the polishing liquid constant for a long time and capable of stably obtaining a high polishing efficiency, as well as capable of efficiently re-utilizing liquid wastes.

In order to overcome the problems described above, the present invention provides, in a first aspect, a polishing liquid used upon polishing a surface of a semiconductor wafer by using an abrasive grain fixed polishing pad in which abrasive grains are incorporated to a polishing pad, the polishing liquid being prepared by mixing at least an inorganic alkali, a salt and an organic alkali into water.

In the invention described above, since the polishing liquid containing the inorganic alkali and the organic alkali has an increased pH value and promotes chemical reaction between the semiconductor wafer and the polishing liquid, it can improve the polishing efficiency for the semiconductor wafer. Further, since the salt is added in the preparation of the polishing liquid, the pH value of the polishing liquid can be kept constant for a long time. As a result, the semiconductor wafer can be polished at a uniform polishing accuracy and, since the polishing liquid shows less time-dependent change of the pH value, the liquid wastes thereof can be re-utilized by recycling.

Further, the salt is prepared by mixing a weak acid and a strong alkali. With such a constitution, since the salt mixed in the polishing liquid is prepared by mixing the strong alkali and the weak acid, it can function as a salt and the ingredient ratio of the polishing liquid can be controlled easily.

Further, the strong alkali may comprise one of materials selected from the group consisting of hydroxides of alkali metal compounds, hydroxides of alkaline earth compounds, ammonia and organic alkalis, or may be prepared by mixing plurality of them.

The polishing liquid is adjusted to a pH value within a range from 10 to 13. With such a constitution, high polishing efficiency and high polishing accuracy can be maintained. That is, in a case where the pH value of the polishing liquid is less than 10, the polishing efficiency is lowered. On the other hand, in a case where the pH value exceeds 13, the chemical reaction is taken place excessively and the semiconductor wafer can no more be polished flat.

The inorganic alkali may comprise one of hydroxides of alkali metal compounds and hydroxides of alkaline earth compounds, or can be prepared by mixing both of them.

The organic alkali may comprise one of ammonia and amine, or can be prepared by mixing them.

The abrasive grain fixed polishing pad comprises at least a polyurethane bonding material having at least a hard segment and a soft segment, and abrasive grains having hydroxyl groups, or abrasive grains provided with hydroxyl groups, in which the molecular weight of the hard segment is adjusted to 20% or more and 60% or less of the entire portion on the basis of the molecular weight ratio. Accordingly, the chemical reaction with the polishing liquid is promoted, and the polishing efficiency of the abrasive grain fixed polishing pad is improved.

The polishing liquid is used in a polishing apparatus for polishing a wafer surface, by using an abrasive grain fixed polishing pad incorporating abrasive grains into a polishing pad, by relative movement with the wafer while supplying the polishing liquid between the wafer and the pad. By using the polishing liquid in such polishing apparatus, the semiconductor wafer can be polished at a uniform polishing accuracy while maintaining a high polishing efficiency.

In the polishing liquid containing the inorganic alkali and the organic alkali of the invention, the pH value increases and the chemical reaction between the semiconductor wafer and the polishing liquid is promoted, and accordingly the polishing efficiency for the semiconductor wafer can be improved. Further, the salt is added when the polishing liquid is prepared, and thus the pH value of the polishing liquid can be maintained constant for a long time. As a result, the semiconductor wafer can be polished at a uniform polishing accuracy, and the liquid wastes can be re-utilized by recycling since the pH value of the polishing liquid shows less time-dependent change.

### BRIEF DESCRIPTION OF THE DRAWING

FIG. 1 is a perspective view schematically showing a polishing apparatus using an abrasive grain fixed polishing pad according to a first embodiment of the invention; and

FIG. 2A and FIG. 2B are perspective views showing, respectively, the constitutions of abrasive grain fixed polishing pad according to the invention.

### DETAILED DESCRIPTION OF PREFERRED EMBODIMENT

The present invention is described specifically by way of preferred embodiments with reference to the accompanying drawings. In the specification and the drawings, those constituent elements having substantially identical functions and constitutions carry same reference numerals, for which duplicate descriptions are to be omitted.

### First Embodiment

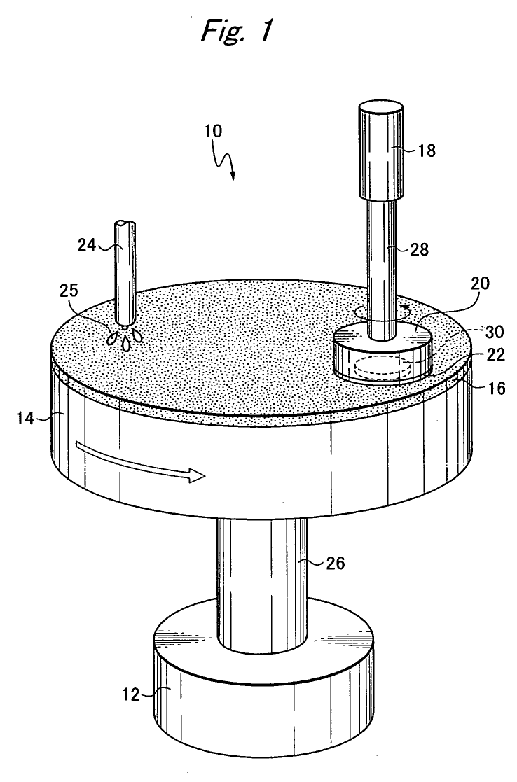

At first, description is to be made to the constitution of a polishing apparatus using an abrasive grain fixed polishing pad according to the first embodiment with reference to FIG. 1. FIG. 1 is a perspective view showing the constitution of a polishing apparatus using an abrasive grain fixed polishing pad according to this embodiment.

A polishing apparatus 10 using an abrasive grain fixed polishing pad according to this embodiment comprises, as shown in FIG. 1, a polishing table 14 which can be rotated by a motor 12, an abrasive grain fixed polishing pad 16 provided over the polishing table 14, a substrate retaining portion 20 for pressing the surface to be polished of a retained semiconductor wafer 30 to the abrasive grain fixed polishing pad 16, a driving device 18 to drive the substrate retaining portion 20 for rotating under pressure, a polishing liquid supply port 24 for supplying a polishing liquid 25 onto the polishing table 14.

The polishing table 14 is a substantially disc-like table formed, for example, of stainless steel or ceramics and has a smooth horizontal surface at the upper surface. The polishing table 14 rotates at a predetermined speed (for example, 40 rpm) in the direction of a fat arrow in FIG. 1 by transmission of a driving force of a motor 12 disposed therebelow within the apparatus by way of a spindle 26 and a speed reducing mechanism (not shown) or the like.

The abrasive grain fixed polishing pad 16 is bonded on the polishing table 14 so as to be flat as much as possible, moves rotationally relative to the semiconductor wafer 30 along with the rotation of the polishing table 14 to polish the surface to be polished of the semiconductor wafer 30 by way of the polishing liquid 25 supplied from the polishing liquid supply port 24.

The driving device 18 is a mechanism for rotating the substrate-retaining portion 20 under pressure through a rod 28 and comprises a motor and a cylinder (not shown) and the like. That is, for example, by the cylinder as a pressure mechanism, it can press the substrate retaining portion 20 for retaining the semiconductor wafer 30 in the direction vertical to the abrasive grain fixed polishing pad 16 and can rotate the substrate retaining portion 20 by the motor as a rotational mechanism in the direction of a fine arrow in FIG. 1. Further, the driving device 18 may be constituted such that the substrate-retaining portion 20 can be caused to swing in a substantially arbitrary horizontal direction.

Further, the substrate-retaining portion (also referred to as polishing head or carrier) 20 entirely has a substantially circular cylindrical shape and is disposed rotationally over the polishing table 14. The substrate-retaining portion 20 is connected with the driving device 18 through the rod 28 and has a ring (retainer ring) 22 for preventing lateral displacement of the semiconductor waver 30 at the lower surface.

In usual polishing, the substrate retaining portion 20 presses the surface to be polished of the semiconductor wafer 30 to the abrasive grains fixed polishing pad 16 while rotating in a state of retaining the semiconductor wafer 30. The semiconductor wafer 30 thus pressed to the abrasive grain fixed polishing pad 16 is frictionally rubbed against the abrasive grain fixed polishing pad 16 that rotates in the opposite direction in both directions to uniformly polish the entire surface to be polished.

The polishing liquid supply nozzle 24 supplies the polishing liquid 25 onto the abrasive grain fixed polishing pad 16 that rotates during polishing of the semiconductor wafer 30. The polishing liquid 25 is an aqueous solution containing chemically reactive substances and intrudes between the semiconductor wafer 30 and the abrasive grain fixed polishing pad 16 during polishing to smooth the surface to be polished of the semiconductor wafer 30 at a high accuracy under chemical reaction with the surface.

As the polishing liquid 25 according to this embodiment, a polishing liquid prepared by mixing at least an inorganic alkali, a salt and an organic alkali in water is used. Details are to be described later. Since the pH value of the polishing liquid containing the inorganic alkali and the organic alkali is increased, the chemical reaction between the semiconductor wafer and the polishing liquid can be promoted to improve the polishing efficiency for the semiconductor wafer. Further, since the salt is added in the preparation of the polishing liquid, the pH value of the polishing liquid can be maintained constant for a long time. As the result, it is possible to polish the semiconductor wafer at a uniform polishing accuracy and, since the pH value of the polishing liquid shows less time-dependent change, it can be used by recycling.

In the polishing apparatus according to this embodiment, a temperature control device (not shown) is disposed to each of the substrate retaining portion (polishing head) 20, the polishing table 14, and the polishing liquid supply nozzle 24, and more preferred polishing can be conducted by setting the temperature for each of the portions appropriately.

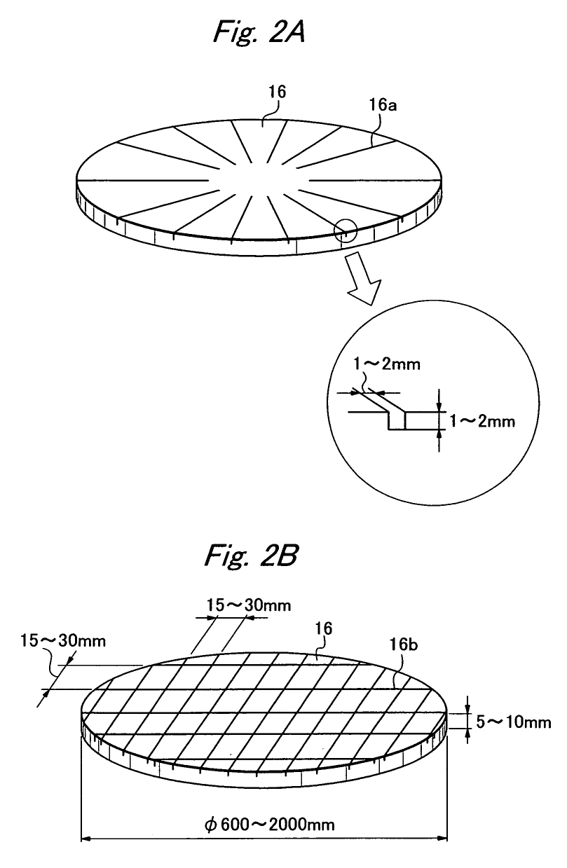

Further, as shown in FIGS. 2A and 2B, grooving fabrication 16a, 16b is applied to the surface of the abrasive grain fixed polishing pad 16 according to this embodiment. Such grooving fabrication is conducted for prevailing the polishing liquid efficiently over the entire abrasive grain fixed polishing pad (particularly, near the center). This can planarize the wafer plane of the semiconductor, improve the polishing rate and prevent thermal expansion due to localized temperature elevation. For example, a radial grooving fabrication as shown in FIG. 2A, or lattice-like grooving fabrication as shown in FIG. 2B can be applied.

Further, the fixed abrasion grain polishing pad 16 according to this embodiment has a constitution in which abrasive grains having hydroxyl groups or abrasive grains provided with hydroxyl groups are incorporated in a polyurethane binder comprising at least a polyfunctional isocyanate, a polyfunctional polyol and a blowing agent of water or carboxylic acid. That is, in the abrasive grain fixed polishing pad according to this embodiment, for example, the hydroxyl groups (—OH) of the abrasive grains (silica) are reacted by way of covalent bond with an isocyanate compound (compound having: —N═C═O) of the binder (urethane) and bonded chemically.

Further, the abrasive grain fixed polishing pad 16 in this embodiment is preferably adjusted such that the molecular weight of the hard segment of the polyurethane comprises 20% to 60% for the entire portion on the basis the molecular weight ratio. By controlling the molecular weight of the hard segment of the polyurethane to 20% or more and 60% or less for the entire portion on the basis the molecular weight ratio, the hydrogen bonding can be promoted for the silicon wafer and the abrasive grains having the hydroxyl groups (or abrasive grains provided with hydroxyl groups). With such hydrogen bond, the binder provides the chemical polishing function relative to the silicon wafer to improve the CMP polishing efficiency, as well as can prevent detachment of abrasive grains in the abrasive grain fixed polishing pad 16.

That is, the abrasive grains per se have hydroxyl groups (or hydroxyl groups are adhered on the surface of the abrasive grains) and the binder has [O—] moiety of the urethane bond. By the hydrogen bond between the hydroxyl groups and the [O—] moiety of the urethane bond, detachment of the abrasive grains from the binder is prevented. Further, since the burden on the abrasive grains is mitigated due to the improvement of the CMP efficiency for the silicon wafer, detachment of the abrasive grains is prevented.

Further, since the urethane bonding amount is in proportion with the molecular weight ratio of the hard segment, even when the molecular weight ratio is 20% or less, urethane bonding is conducted to attain a state for promoting the hydrogen bond more or less. However, at the molecular weight ratio of 20% or less, since the urethane bonding amount is insufficient, it can not contribute to the improvement of the polishing performance (polishing rate). On the other hand, at a molecular weight ratio of 60% or more, since the hard segment is excessive, this results in a state where the hardness of the polishing pad is excessively high to bring about a problem that scratches are caused in the semiconductor wafer.

With the reasons described above, it is considered that the hydrogen bond can be promoted when the molecular weight of the hard segment in the polyurethane binder is controlled to 20% or more and 60% or less for the entire amount on the basis of the molecular weight ratio.

As the polishing liquid 25 according to this embodiment, a polishing liquid prepared by mixing an inorganic alkali, a salt and an organic alkali is used. In the polishing liquid according to this embodiment, since two different types of alkalis, i.e., the inorganic alkali and the organic alkali are used, the chemical reaction between the semiconductor wafer and the polishing liquid can be promoted more compared with the case of using them individually. Further, the chemical reaction means that the hydroxyl groups (OH—) are provided from the polishing liquid to the surface of the semiconductor wafer and bonded chemically to form hydrogen bonds with polar groups constituting the hard segment of the abrasive grain fixed polishing pad 16 or with the hydroxyl groups of abrasive grains contained in the abrasive grain fixed polishing pad 16, or cause dewatering reaction between the hydroxyl groups to each other, thereby polishing the surface of the semiconductor wafer.

While the detailed reasons why the chemical reaction is promoted by the use of the two different types of alkalis are not apparent, it may be considered as follows. That is, while potassium hydroxide (KOH) as the inorganic alkali is present being separated as K⁺ and OH⁻ in the polishing liquid, ammonia (NH₃) as the organic alkali is reacted with water in the polishing liquid and is present being separated as NH₄⁺ and OH⁻. It is supposed that a synergistic effect of the chemical reactions occurs by the reason that the state of forming the hydroxyl groups (OH⁻) is different.

As described above, by incorporation of the inorganic alkali and the organic alkali in the polishing liquid, since the pH value of the polishing liquid increases to promote the chemical reaction, the polishing efficiency for the semiconductor wafer can be improved. However, the pH value of the polishing solution cannot be maintained for long time and the pH value of the polishing liquid is remarkably lowered with lapse of time. Accordingly, it is obliged to frequently exchange the polishing liquid in order to keep the quality (pH value) of the polishing liquid constant. Therefore, not only increases the production cost but also impairs the advantageous feature of the polishing method of the abrasive grain fixed polishing pad 16 that the polishing liquid can be re-utilized easily.

For avoiding such a problem and maintaining the pH value of the polishing solution for a long time, a constitution of admixing the salt upon mixing the inorganic alkali and the organic alkali is adopted in this embodiment. As described above, a high pH value of the polishing liquid can be maintained for a long time by preparing the polishing liquid by mixing the inorganic alkali, the salt and the organic alkali into water.

In this case, the pH value of the polishing liquid is preferably within a range from 10 to 13. That is, in a case where the pH value of the polishing liquid is less than 10, the polishing efficiency is lowered. On the other hand, in a case where the pH value exceeds 13, the chemical reaction proceeds excessively and accordingly the semiconductor wafer can be no more planarized polishing.

The polishing liquid according to this embodiment is prepared by mixing the inorganic alkali, the salt and the organic alkali into water. Details are to be described below.

The inorganic alkali according to this embodiment is one of hydroxides of alkali metal compounds and hydroxides of alkaline earth compounds, or prepared by mixing both of them. The hydroxides of the alkali metal compounds include, for example, lithium hydroxide, sodium hydroxide, and potassium hydroxide, and hydroxides of the alkaline earth compounds can be selected, for example, from the group consisting of calcium hydroxide, strontium hydroxide, and barium hydroxide.

Further, the organic alkali according to this embodiment is one of ammonia and amine, or prepared by mixing both of them. The amine has no particular restriction so long as it is a water soluble amine. For example, the water soluble amine includes aniline, monoethanolamine, diethanolamine, triethanolamine, piperazine, 1,6-hexadiamine hydrazine, ethylamine, diethylamine, triethylamine, methylamine, dimethylamine, trimethylamine, isopropanolamine, aminoethylethanolamine, aminoethyl -pyperazine, ethylenediamine, diethylenetriamine, tetraethylenepentamine, triethylene -tetramine, hexamethylenetetramine, and pentaethylenehexamine.

The salt in this embodiment is prepared by mixing a strong alkali and a weak acid. As the strong alkali, a hydroxide of an alkali metal compound or a hydroxide of an alkaline earth compound is used and mixed respectively with a weak acid such as boric acid, phosphoric add, hypochlorous acid, hypobromous acid, hypoiodic acid, carbonic acid, formic acid, acetic acid, benzoic acid, or the like. For example, the salt can be selected from the group consisting of ammonium carbonate, ammonium hydrogen carbonate, ammonium carbamate, lithium carbonate, sodium carbonate, sodium hydrogen carbonate, potassium carbonate, potassium hydrogen carbonate, calcium carbonate, strontium carbonate, and barium carbonate.

Further, in this embodiment, a chelating agent may also be added optionally for removing contaminants. The chelating agent includes, for example, ethylenediamine tetraacetc acid, disodium ethylenediamine tetraacetate, diethylene triamine pentaacetic acid, propylenediamine tetraacetc acid, hydroxyethylethylene diamine triacetic acid, glycol ether diamine tetraacetic add, nitrilo triacetic acid, hydroxyethylimino diacetic acid, dihydroxyethyl glycine, and triethylene tetramine hexaacetic acid, oxalic acid, acetylacetone, 2,2′-bipyridine, and like other compounds. Among them, ethylenediamine tetraacetic acid, disodium ethylenediamine tetraacetate, diethylene triamine pentaacetic acid, propylenediamine tetraacetic acid, hydroxyethylethylene diamine triacetic add, glycol ether diamine tetraacetic acid, nitrilo triacetic acid, hydroxyethylethylene diamine triacetic acid, dihydroxyethylglycine, and tetraethylene tetraamine hexaacetic acid.

While the strong alkali used for the salt may sometimes be identical with the ingredients of the organic alkali or the inorganic alkali, since this is in a state of the salt prepared by mixing the strong alkali and the weak acid, the strong acid does not function in the manner identical with the organic alkali or the inorganic alkali. Further, the salt can not function as the buffer salt and can not control the ingredient ratio unless it is once prepared previously as the salt by mixing the strong alkali and the weak add.

Since the polishing liquid containing the inorganic alkali and the organic alkali in this embodiment can promote the chemical reaction between the semiconductor wafer and the polishing liquid due to the increase pH value, it can improve the polishing efficiency for the semiconductor wafer. Further, since the salt is added upon preparation of the polishing liquid, the pH value of the polishing liquid can be kept constant for long time. As a result, the semiconductor wafer can be polished at a uniform polishing accuracy, and since the pH value of the polishing liquid shows less time-dependent change, liquid wastes can be re-utilized by recycling.

### EXAMPLE

Then, the abrasive grain fixed polishing pad 16 was prepared based on the embodiment described above and the polishing efficiency for the article to be polished, etc. were investigated by using various kinds of polishing liquids, and they were described below specifically.

In this investigation, 7 kinds of polishing liquids were used for an identical abrasive grain fixed polishing pad 16 (Test Examples 1 to 7) and compared with a polishing liquid of an Example according to this invention. Further, as a comparative example to the abrasive grain fixed polishing pad 16, a commercially available polishing pad of free abrasive grain type was used.

In Test Example 1, a polishing liquid obtained by mixing only an inorganic alkali into water was used. In Test Example 2, a polishing liquid obtained by mixing only a salt comprising a strong alkali and a weak acid into water was used. In Test Example 3, a polishing liquid obtained by mixing only a salt comprising a weak alkali and a weak acid into water was used. In Test Example 4, a polishing liquid obtained by mixing only a salt comprising a weak alkali and a strong acid into water was used. In Test Example 5, a polishing liquid obtained by mixing only a salt comprising a strong alkali and a weak acid into water was used. In Test Example 6, a polishing liquid obtained by mixing only an organic alkali into water was used. In Test Example 7, a polishing liquid formed by mixing an inorganic alkali and an organic alkali into water was used. In Example of the invention, a polishing liquid formed by mixing an inorganic alkali, an organic alkali, and a salt into water was used.

Further, as the comparative example, commercially available polishing pad of free abrasive grain type (SUBA400 manufactured by Rodel Nitta Company) and a polishing liquid (COMPOLE 80 manufactured by Fujimi Incorporated) were used. An example of polishing the silicon wafer was shown.

The abrasive grain fixed polishing pad 16 was manufactured by blending a polyether polyol with a molecular weight of 250 to 4000 and the number of functional groups of 2 to 5 (SANNIX, trade name of products manufactured by Sanyo Chemical Industries, Ltd.), a polyester polyol (ADECA NEWACE, trade name of products manufactured by Asahi Denka Co. Ltd.; DESMOFEN, BYCOL, trade name of products manufactured by Sumitomo Bayer Urethane Co., Ltd.), isocyanate with an isocyanate NCO group content of 31% (PAPI 135, trade name of products manufactured by Dow Polyurethane Co., Ltd.), water, amine catalyst (TOYOCAT-ET, trade name of products manufactured by Tosoh Corporation), silicone foam controller (L-5309, trade name of products manufactured by Nippon Unicar Company Limited) and abrasive grains (Colloidal silica: manufactured by Fuso Chemical Co., Ltd., Fumed silica: manufactured by Shin-Etsu Quartz Products Co., Ltd., grain size each in 2 to 8 μm) at a determined ratio (parts by weight) to prepare a liquid mixture, pouring the liquid mixture poured into a die, leaving at a room temperature of 20 to 30° C. for 24 hours, and causing the same to blow and cure to prepare the pad.

The abrasive grain fixed polishing pad 16 was bonded to a surface plate of a polishing machine by an adhesive tape and the surface of the abrasive grain fixed polishing pad 16 was amended by an amending ring electro-deposited with diamond to obtain a polishing pad of 9 mm thickness with the foamed structure being exposed at the surface. An article to be polished was pressed to the abrasive grain fixed polishing pad 16 and the article to be polished was subjected to polishing by a relative movement between the abrasive grain fixed polishing pad 16 and the article to be polished while supplying the polishing liquid between the abrasive grain fixed polishing pad 16 and the article to be polished.

0.04% by weight of sodium hydroxide was mixed into water as the inorganic alkali. Further, 0.12% by weight of sodium carbonate was mixed into water as the salt comprising a strong alkali and a weak acid. 0.12% by weight of ammonium acetate was mixed into water as the salt comprising a weak alkali and a weak acid. 0.12% by weight of ammonium chloride was mixed into water as the salt comprising a weak alkali and a strong acid. Further, 0.12% by weight of sodium chloride was mixed into water as the salt comprising a strong alkali and a strong acid. Further, 0.05% by weight of ethylene diamine was mixed into water as the organic alkali.

[Polishing condition]

Polishing pressure: 200 gwt/cm²
Number of rotation of surface plate (φ4650): 80 rpm

[Result of Experiment]

TABLE 1

| | | Test | Test | Test | Test | Test | Test | Test | | Comp. |
|---|---|---|---|---|---|---|---|---|---|---|
| | | Ex. 1 | Ex. 2 | Ex. 3 | Ex. 4 | Ex. 5 | Ex. 6 | Ex. 7 | Example | Example |
| Composition | Sodium | 0.04 | | | | | | 0.04 | 0.04 | |
| (wt %) | hydroxide | | | | | | | | | |
| | Sodium | | 0.12 | | | | | | 0.12 | |
| | carbonate | | | | | | | | | |
| | Ammonium | | | 0.12 | | | | | | |
| | acetate | | | | | | | | | |
| | Ammonium | | | | 0.12 | | | | | |
| | chloride | | | | | | | | | |
| | Sodium | | | | | 0.12 | | | | |
| | chloride | | | | | | | | | |
| | Ethylene | | | | | | 0.05 | 0.05 | 0.05 | |
| | diamine | | | | | | | | | |
| pH value of | Initial | 11.7 | 11.6 | 7 | 4 | 7 | 10.6 | 11.8 | 11.8 | 11.3 |
| polishing | 24 hr after kept | 11.3 | 11.5 | | | | 10.2 | 11.1 | 11.6 | 10.8 |
| liquid | at 50° C. | | | | | | | | | |
| Polishing | Initial | 0.48 | 0.52 | 0 | 0 | 0 | 0.55 | 0.63 | 0.65 | 0.33 |
| rate | 24 hr after kept | 0.35 | 0.51 | | | | 0.42 | 0.49 | 0.63 | 0.19 |
| [μm/min] | at 50° C. | | | | | | | | | |

(1) Polished State

As shown in Table 1 above, polishing could be conducted in the initial stage in Test Examples 1 and 2, and Test Examples 6 and 7, and Example according to the invention. In Test Examples 3 to 5, polishing could not be conducted since the pH value was lowered excessively.

(2) Polishing Rate

As shown in Table 1 above, the polishing rate was about 0.5 μm/min, which was substantially constant at the initial stage in Test Examples 1, 2 and 6. On the contrary, in Test Example 7 and Example according to the invention, a polishing rate at a value larger than in Test Examples 1, 2 and 6 was obtained in the initial stage. Further, in a case of keeping the polishing liquid at 50° C. for 24 hours, the polishing rate was scarcely lowered in Test Example 2 and Example according to the invention.

### COMPARATIVE EXAMPLE

Further, in the comparative example, the polishing rate was lowered compared with the case of using the abrasive grain fixed pad. For this reason, it is estimated that since the polishing liquid was prepared only with the organic alkali, the time-dependent change of the pH value was remarkable. Further, in a case of keeping the polishing liquid at 50° C. for 24 hours, it was observed a phenomenon that loose abrasives were agglomerated and the polishing rate was lowered.

In view of the result of the experiment, satisfactory results were obtained both for the polishing state and the polishing rate for the semiconductor wafer by using the polishing liquid obtained by mixing the inorganic alkali, the organic alkali and the salt into water of Example according to the invention. In view of the above, it is considered most appropriate to use the polishing liquid formed by mixing the inorganic alkali, the organic alkali, and the salt into water of Example according to the invention.

While the present invention has been described for preferred embodiments with reference to the accompanying drawings, it should be understood that the invention is not restricted only to such examples. It is apparent that those skilled in the art can reach various improved examples or modified examples within a range described in the scope of the claim for patent and they also belong to the technical range of the invention.

The present invention is applicable to a polishing liquid and a polishing apparatus and, more specifically, it is applicable to a polishing liquid used upon polishing the surface of a semiconductor wafer by using an abrasive grain fixed polishing pad in which abrasive grains are incorporated in a polishing pad, as well as a polishing apparatus using such polishing liquid.

1. A polishing liquid used upon polishing a surface of a semiconductor wafer by using an abrasive grain fixed polishing pad in which abrasive grains are incorporated to a polishing pad, wherein the polishing liquid is obtainable by mixing at least an inorganic alkali, a salt, and an organic alkali.

2. A polishing liquid according to claim 1, wherein the salt is obtainable by mixing a weak acid and a strong alkali.

3. A polishing liquid according to claim 2, wherein
the strong alkali is one of materials selected from the group consisting of hydroxides of alkali metal, hydroxides of alkaline earth metals, ammonia, and organic alkalis, or mixtures thereof.

4. A polishing liquid according to claim 1, wherein the inorganic alkali is one of hydroxides of alkali metals and alkaline earth metals, or mixtures thereof.

5. A polishing liquid according to claim 1, wherein the organic alkali is one of ammonia and amine, or mixtures thereof.

6. A polishing liquid according to claim 1, wherein pH value of the polishing liquid is adjusted within a range of 10 to 13.

7. A polishing liquid according to claim 2, wherein pH value of the polishing liquid is adjusted within a range of 10 to 13.

8. A polishing liquid according to claim 3, wherein pH value of the polishing liquid is adjusted within a range of 10 to 13.

9. A polishing liquid according to claim 4, wherein pH value of the polishing liquid is adjusted within a range of 10 to 13.

10. A polishing liquid according to claim 5, wherein pH value of the polishing liquid is adjusted within a range of 10 to 13.
